(19) United States
(12) Patent Application Publication
(10) Pub. No.: US 2002/0080511 A1
(43) Pub. Date: Jun. 27, 2002

(54) Floppy disk drive preventing data errors from occurring on side of main controller coupled via set cable

(75) Inventor: Mikio Sekine, Fukushima-ken (JP)

Correspondence Address: Brinks Hofer Gilson & Lione, P.O. Box 10395, Chicago, IL, 60610, US

(73) Assignee: Alps Electric Co., Ltd.

(21) Appl. No.: 10/016,909

(22) Filed: Dec. 14, 2001

(30) Foreign Application Priority Data
Dec. 27, 2000 (JP) 2000-398739

(51) Int. Cl. G11B 5/02

(52) U.S. Cl. 360/67

(57) ABSTRACT

A floppy disk drive comprises at least a data read/write-unit for reading or writing data through a head, motor drivers for driving a spindle motor and a stepping motor, a control unit for controlling overall operation of the floppy disk drive, and a data output unit for supplying data to a main controller via a set cable. The data output unit comprises an output transistor outputting the data to the set cable and supplied with a pull-up current from the main controller via the set cable, and a pull-up transistor and a pull-down transistor connected in series between a power source terminal and a ground. The pull-up transistor and the pull-down transistor drive the output transistor in cooperation, and a current limiting resistance is connected in series to the pull-down transistor.

### BACKGROUND OF THE INVENTION

1. Field of the Invention

The present invention relates to a floppy disk drive, and more particularly to a floppy disk drive in which, when the floppy disk drive is coupled to a main controller via a set cable and data is transmitted to the main controller via the set cable, data errors are prevented from occurring on the main controller side upon fluctuations in rising edges of data waveforms under effects of, e.g., an inductance of the set cable.

2. Description of the Related Art

Generally, a floppy disk drive (FDD) is used in combination with a main controller comprising a personal computer (PC), for example, to constitute an information recording and reproducing apparatus as an entire system. The floppy disk drive and the main controller are coupled to each other by a set cable for transferring various data between them.

FIG. 3 is a block diagram schematically showing one example of a conventional information recording and reproducing apparatus comprising a floppy disk drive and a main controller.

As shown in FIG. 3, the conventional information recording and reproducing apparatus comprises a floppy disk drive (FDD) 31, a main controller 32 constituted by a personal computer (PC), and set cables 33 for coupling the floppy disk drive 31 and the main controller 32 to each other.

The floppy disk drive 31 includes at least a control unit 34 for controlling the entirety of the floppy disk drive in a supervising manner; a data read/write (R/W) unit 35 having a head (not shown) for accessing a floppy disk (also not shown) to read or write information from or in the floppy disk through the head; a spindle motor (SPM) driver 36 for rotating the floppy disk; a stepping motor (STM) driver 37 for moving the head to a predetermined position in a stepwise manner; and a data output unit 38 for outputting various data. Also, the main controller 32 includes at least a read data (RD) input unit 39 and an index data (IDx) input unit 40.

In the floppy disk drive 31, the control unit 34 is connected to the data read/write unit 35, the spindle motor driver 36 and the stepping motor driver 37, and it is also connected to an input terminal of the data output unit 38. Output terminals of the data output unit 38 are connected to one-side ends of the set cables 33. In the main controller 32, an input terminal of the read data input unit 39 and an input terminal of the index data input unit 40 are connected to the other-side ends of the set cables 33.

In the information recording and reproducing apparatus thus constructed, when write data is supplied from the side of the main controller 32 to the floppy disk drive 31 via the set cable 33, the write data is supplied to the head through the data read/write unit 35 and written in the floppy disk at a predetermined position under control of the control unit 34. On the other hand, read data read out of a predetermined position of the disk drive through the head is supplied from the data read/write unit 35 to the data output unit 38 under control of the control unit 34, and then supplied from the data output unit 38 to the side of the main controller 32 via the set cable 33.

FIG. 4 is a circuit diagram schematically showing a first circuit example (referred to as a “first circuit” hereinafter) of the data output unit 38 and the read data input unit 39 shown in FIG. 3.

As shown in FIG. 4, the data output unit 38 comprises at least an output transistor 38₁, a driving transistor 38₂, an emitter serial resistance 38₃, voltage-dividing base resistances 38₄, 38₅, an intra-drive data output terminal 38₆, an intra-drive data input terminal 38₇, and a power source terminal 38₈. The read data input unit 39 comprises at least a pull-up resistance 39₁, and a data input terminal 39₂. The set cable 33 has a serial inductance L and a distributed capacitance C as equivalent values. Those components 33, 38₁ to 38₉, and 39₁ to 39₂ are connected, as shown in FIG. 4, to form the first circuit.

FIG. 5 is a waveform chart showing read data obtained at the data input terminal 392 and a data detection signal outputted from the read data input unit 39 in the first circuit shown in FIG. 3.

Referring to FIG. 5, a solid line a represents the read data obtained at the data input terminal 39₂, a dotted line b represents intra-drive read data supplied to the intra-drive data input terminal 38₇, one-dot-chain lines c₁, c₂ represent two thresholds described later, and d represents the data detection signal.

The operation of the first circuit shown in FIG. 4 will be described below with reference to the waveform chart of FIG. 5 as well.

In the floppy disk drive 31, when data recorded on a floppy disk is read, the intra-drive read data is supplied to the intra-drive data input terminal 38₇ at predetermined timing. The waveform of the intra-drive read data at that time is substantially rectangular as indicated by the dotted line b in FIG. 5. Then, the intra-drive read data is supplied to the driving transistor 38₂ after being adjusted in level by the voltage-dividing base resistances 38₄, 38₅. When the intra-drive read data is at a positive level, the driving transistor 38₂ is driven and supplies a pull-up current to the output transistor 38₁ through the emitter serial resistance 38₃. Upon the supply of the pull-up current, the output transistor 38₁ is turned on and a collector current flows into the output transistor 38₁ through the pull-up resistor 39₁ and the set cable 33, whereby the intra-drive read data is amplified with the phase inverted. The read data having the inverted phase is supplied from the intra-drive data output terminal 38₆ to the data input terminal 39₂ via the set cable 33 so that the read data is inputted to the read data input unit 39. The waveform of the read data at this time is as represented by the solid line a in FIG. 5; that is, it has the phase inverted with respect to the waveform of the intra-drive read data represented by the dotted line b and has a rising edge sloped due to the inductance L and the distributed capacitance C of the set cable 33, as well as to a delay in off-operation resulting from, e.g., the charge accumulation effect of the driving transistor 38₂.

When the read data is supplied, the read data input unit 39 performs data detection using the rising and falling edges of the read data. More specifically, the read data input unit 39 has the two thresholds c₁, c₂ as represented by the one-dot-chain lines in FIG. 5. At the time the falling edge of the supplied read data intersects the lower threshold c₁, the data detection signal d at a low level (L-level) is outputted, and then at the time the rising edge of the supplied read data intersects the upper threshold c₂, the data detection signal d shifts to a high level (H-level), whereupon the outputting of the data detection signal d is stopped. As a result, the data detection signal d shown in FIG. 5 is outputted.

In the first circuit shown in FIG. 4, not only the rising edge of the read data supplied to the read data input unit 39 has a gentle slope, but also the timing of the rising edge of the read data is delayed from an arrival time to of a falling edge of the intra-drive read data supplied to the intra-drive data input terminal 38₇. Therefore, the stop time (rising edge) of outputting of the data detection signal d outputted from the data input unit 39 has a relatively long time delay td from the arrival time t₀ of the falling edge of the intra-drive read data. The duration time (width) of the data detection signal d is hence increased, which adversely affects the operation of the information recording and reproducing apparatus.

To overcome the above-described problem, it has been already proposed to modify the data output unit 38 somewhat for steeping the slope of the rising edge of the read data supplied to the read data input unit 39 and reducing the time delay td of the rising edge of the read data. One example of such an improved circuit arrangement is shown in FIG. 6.

FIG. 6 is a circuit diagram showing one example of the improved circuit arrangement, i.e., a second circuit example (referred to as a “second circuit” hereinafter) of the data output unit 38 and the read data input unit 39 shown in FIG. 3. Note that, in FIG. 6, the same components as those shown in FIG. 4 are denoted by the same characters.

As shown in FIG. 6, the data output unit 38 comprises, similarly to the first circuit shown in FIG. 4, at least an output transistor 38₁, a pull-up driving transistor 38₂, an emitter serial resistance 38₃, voltage-dividing base resistances 38₄, 38₅, an intra-drive data output terminal 38₆, an intra-drive data input terminal 38₇, and a power source terminal 38₈. In addition, the data output unit 38 further comprises a pull-down driving field effect transistor 38₉ for adjusting the duration time (width) of the data detection signal d and complementary field effect transistors 38₁₀, 38₁₁ having grounded sources. The read data input unit 39 comprises, similarly to the first circuit shown in FIG. 4, at least a pull-up resistance 39₁ and a data input terminal 39₂. The set cable 33 also has, similarly to the first circuit shown in FIG. 4, a serial inductance L and a distributed capacitance C as equivalent values. Those components 33, 38₁ to 38₁₁, and 39₁ to 39₂ are connected, as shown in FIG. 6, to form the second circuit.

FIG. 7 is a waveform chart showing read data obtained at the data input terminal 39₂ and a data detection signal outputted from the read data input unit 39 in the second circuit shown in FIG. 6.

Referring to FIG. 7, a solid line a represents the read data obtained at the data input terminal 39₂, a dotted line b represents intra-drive read data supplied to the intra-drive data input terminal 38₇, one-dot-chain lines c₁, c₂ represent two thresholds, and d represents the data detection signal.

The operation of the second circuit shown in FIG. 6 will be described below with reference to the waveform chart of FIG. 7 as well.

When data recorded on a floppy disk is read, the intra-drive read data is supplied to the intra-drive data input terminal 38₇ at predetermined timing. The waveform of the intra-drive read data at that time is substantially rectangular as indicated by the dotted line b in FIG. 7. Then, the intra-drive read data is divided into two parts, one of which is supplied to the pull-up driving transistor 38₂ after being adjusted in level by the voltage-dividing base resistances 38₄, 38₅. When the intra-drive read data is at a positive level, the pull-up driving transistor 38₂ is driven and supplies a pull-up current to the output transistor 38₁ through the emitter serial resistance 38₃. Upon the supply of the pull-up current, the output transistor 38₁ is turned on and a collector current flows into the output transistor 38₁ through the pull-up resistor 39₁ and the set cable 33, whereby the intra-drive read data is amplified with the phase inverted. The other part of the intra-drive read data is amplified by the complementary field effect transistors 38₁₀, 38₁₁ with the phase inverted and then supplied to the pull-down driving field effect transistor 38₉. When the intra-drive read data applied to the intra-drive data input terminal 38₇ takes a zero level (L-level), the pull-down driving field effect transistor 38₉ is driven and gains a pull-down current from the base of the output transistor 38₁. Thus, the pull-down driving field effect transistor 38₉ functions to quickly attenuate a residual current due to the charge accumulation effect of the pull-up driving transistor 38₂, and to more promptly cut off the output transistor 38₁. The read data obtained from the output transistor 38₁ through the above-described cooperative operations and having the inverted phase is supplied from the intra-drive data output terminal 38₆ to the data input terminal 39₂ via the set cable 33 so that the read data is inputted to the read data input unit 39. The waveform of the read data at this time is as represented by the solid line a in FIG. 7; that is, it has the phase inverted with respect to the waveform of the intra-drive read data represented by the dotted line b and has a rising edge with a relatively steep slope because the read data is subjected to the effect of the inductance L of the set cable 33, but hardly affected by the charge accumulation effect of the pull-up driving transistor 38₂.

Also in the second circuit, the read data input unit 39 has the two thresholds c₁, c₂ as represented by the one-dot-chain lines in FIG. 7. At the time the falling edge of the supplied read data intersects the lower threshold c₁, the data detection signal d at a low level (L-level) is outputted, and then at the time the rising edge of the supplied read data intersects the upper threshold c₂, the data detection signal d shifts to a high level (H-level), whereupon the outputting of the data detection signal d is stopped.

In the second circuit, not only the rising edge of the read data supplied to the read data input unit 39 has a relatively steep slope, but also the timing of the rising edge of the read data is closer to an arrival time t₀ of a falling edge of the intra-drive read data supplied to the intra-drive data input terminal 38₇. Therefore, the stop time (rising edge) of outputting of the data detection signal d outputted from the data input unit 39 has a relatively short time delay td from the arrival time t₀ of the falling edge of the intra-drive read data. An adverse effect upon the operation of the information recording and reproducing apparatus is hence eliminated.

In general, when data is transferred via a set cable, the data transmitted via the set cable is reflected by the presence of an inductance of the set cable, whereupon undulations may occur in the waveform of the data at its rising edge.

In the first circuit described above, undulations in the waveform of the rising edge of the read data are relatively small, but the stop time of outputting of the data detection signal d has the relatively long time delay td relative to the arrival time t₀ of the falling edge of the intra-drive read data. On the other hand, in the second circuit described above, the stop time of outputting of the data detection signal d is closer to the arrival time t₀ of the falling edge of the intra-drive read data and the time delay td is short, but undulations in the waveform of the rising edge of the read data are relatively large. Any of the first and second circuits having those characteristics is not satisfactory for the operation of the information recording and reproducing apparatus.

Usually, the main controller 32 including the read data input unit 39 is constituted by a set of several integrated circuits (ICs), and the read data input unit 39 is also incorporated as a part of the integrated circuits. In such a case, the read data input unit 39 is made up of a first circuit section for generating the two thresholds c₁, c₂, a second circuit section for detecting the fact that the rising edge of the read data intersects the lower threshold c₁ and then intersects the upper threshold c₂, a third circuit section for stopping the outputting of the data detection signal d, etc. The circuit arrangement and circuit constants of the integrated circuits are set such that the first circuit section generates the two thresholds c₁, c₂.

However, recently commercialized integrated circuits are often designed such that the first circuit section has the two thresholds c₁, c₂, but these two thresholds c₁, c₂ are relatively close to each other.

FIGS. 8A and 8B are explanatory charts showing the relationship between a portion of the rising edge of the read data and a spacing between the two thresholds c₁, c₂. FIG. 8A represents the case in which the spacing between the two thresholds c₁, c₂ is relatively wide, and FIG. 8B represents the case in which the spacing between the two thresholds c₁, c₂ is relatively narrow.

In FIGS. 8A and 8B, a solid line a represents the rising edge of the read data, one-dot-chain lines c₁, c₂ represent the two thresholds, and d represents a data detection signal.

In the case in which the spacing between the two thresholds c₁, c₂ is relatively wide, as shown in FIG. 8A, even if there are undulations in the waveform of the rising edge a of the read data, the second circuit section detects the arrival of the rising edge a at the time the rising edge a intersects the upper threshold c₂ for the first time after intersecting the lower threshold c₁. In response to the detection of the arrival of the rising edge a, the third circuit section stops the outputting of the data detection signal d. Accordingly, the proper data detection signal d can be obtained from the read data input unit 39 because the outputting of the data detection signal d is stopped only once each time the rising edge a of the read data arrives once.

On the other hand, in the case in which the spacing between the two thresholds c₁, c₂ is relatively narrow, as shown in FIG. 8B, if there are relatively large undulations in the waveform of the rising edge a of the read data, the following problem occurs. The data detection signal is outputted at the time a falling edge intersects the lower threshold c₁. Then, the outputting of the data detection signal is stopped at the time a rising side of one convex portion of the undulations in the rising edge a of the read data intersects the upper threshold c₂. Subsequently, the data detection signal is outputted again at the time a falling side of the one convex undulation (or of an adjacent concave undulation) in the rising edge a intersects the lower threshold c₁. Then, the outputting of the data detection signal is stopped again at the time a rising side of the adjacent concave undulation in the rising edge a intersects the upper threshold c₂. In this way, two data detection signals d1, d2 are generated. In spite of the falling edge of the read data being arrived only once, the read data input unit 39 generates the two data detection signals d1, d2. In other words, the false data detection signal d2 is generated in addition to the proper data detection signal d1.

### SUMMARY OF THE INVENTION

In view of the technical background set forth above, it is an object of the present invention to provide a floppy disk drive in which a time interval between the stop time of outputting of a data detection signal and the arrival time of a falling edge of read data is small, and a false data detection signal is not generated.

To achieve the above object, a floppy disk drive according to the present invention comprises at least a data read/write unit for reading or writing data through a head, motor drivers for driving a spindle motor and a stepping motor, a control unit for controlling overall operation of the floppy disk drive, and a data output unit for supplying data to a main controller via a set cable, the data output unit comprising an output transistor outputting the data to the set cable and supplied with a pull-up current from the main controller via the set cable, and a pull-up transistor and a pull-down transistor connected in series between a power source terminal and a ground, wherein the pull-up transistor and the pull-down transistor include driving transistors for driving the output transistor in cooperation, and a current limiting resistance is connected in series to the pull-down transistor.

With those features, since the current limiting resistance is connected in series to the pull-down transistor to limit a current flowing through the pull-down transistor when the output transistor is turned off, a time delay of a rising edge of read data can be reduced, and a read data input unit is able to reliably generate one data detection signal each time the falling edge of the read data arrives once, and is surely kept from generating a false data detection signal.

In the above floppy disk drive, preferably, the pull-up transistor is a transistor having an emitter serial resistance and connected in emitter follower arrangement, and the pull-down transistor is a field effect transistor having a grounded source with the current limiting resistance connected to a drain of the field effect transistor.

With those features, a relatively simple circuit arrangement is achieved and the data output unit can be easily realized in the form of an integrated circuit.

In the above floppy disk drive, preferably, the current limiting resistance has a resistance value several times a resistance value of the emitter serial resistance.

With that feature, the pull-down current flows through the pull-down transistor at a proper value, undulations occurred in the waveform of the rising edge of the read data can be suppressed with certainty.

### BRIEF DESCRIPTION OF THE DRAWINGS

FIG. 1 is a schematic circuit diagram of one example of a data output unit and a read data input unit, showing one embodiment of a floppy disk drive according to the present invention;

FIG. 2 is a waveform chart showing read data obtained at a data input terminal and a data detection signal outputted from the read data input unit in the embodiment shown in FIG. 1;

FIG. 3 is a block diagram schematically showing one example of a conventional information recording and reproducing apparatus comprising a floppy disk drive and a main controller;

FIG. 4 is a circuit diagram schematically showing a first circuit example of a data output unit and a read data input unit shown in FIG. 3;

FIG. 5 is a waveform chart showing read data obtained at a data input terminal and a data detection signal outputted from the read data input unit in the first circuit example shown in FIG. 4;

FIG. 6 is a circuit diagram schematically showing a second circuit example of the data output unit and the read data input unit shown in FIG. 3;

FIG. 7 is a waveform chart showing read data obtained at a data input terminal and a data detection signal outputted from the read data input unit in the second circuit example shown in FIG. 6; and

FIGS. 8A and BB are explanatory charts showing the relationship between a portion of a rising edge of the read data and a spacing between two thresholds.

### DESCRIPTION OF THE PREFERRED EMBODIMENTS

A preferred embodiment of the present invention will be described below with reference to the drawings.

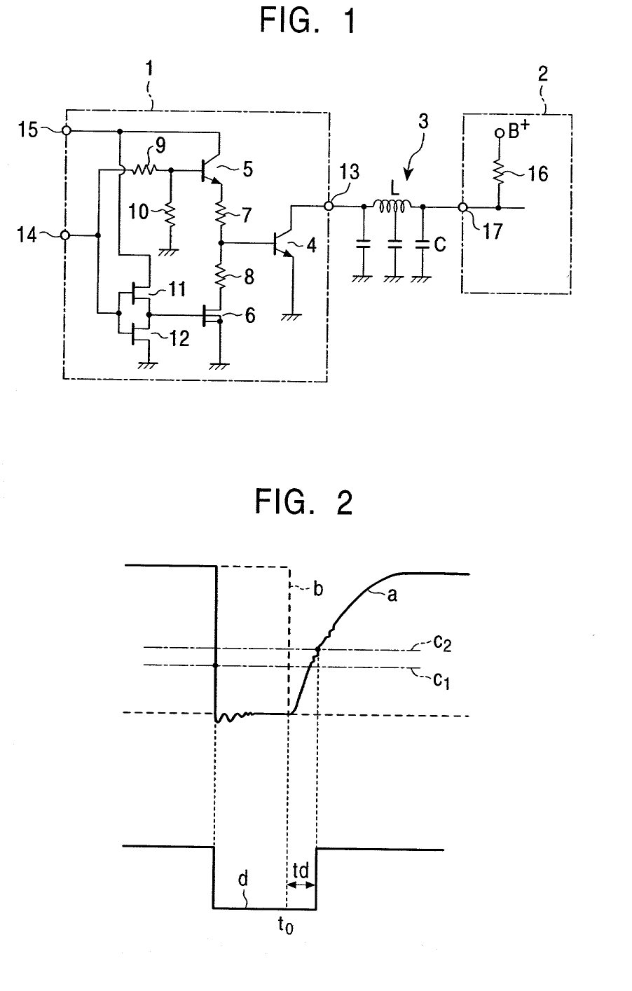

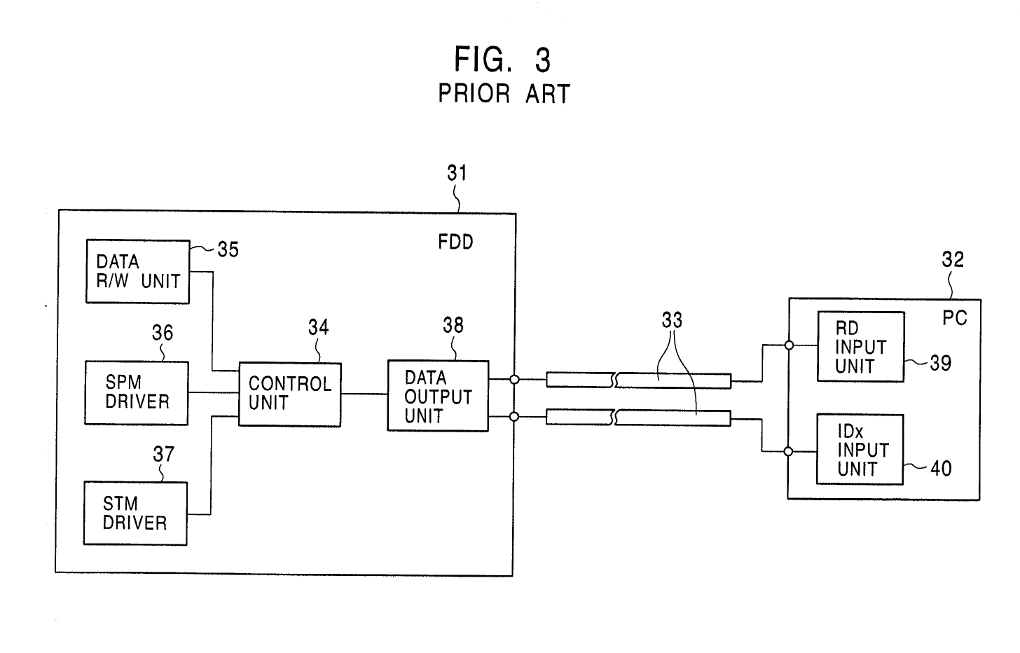

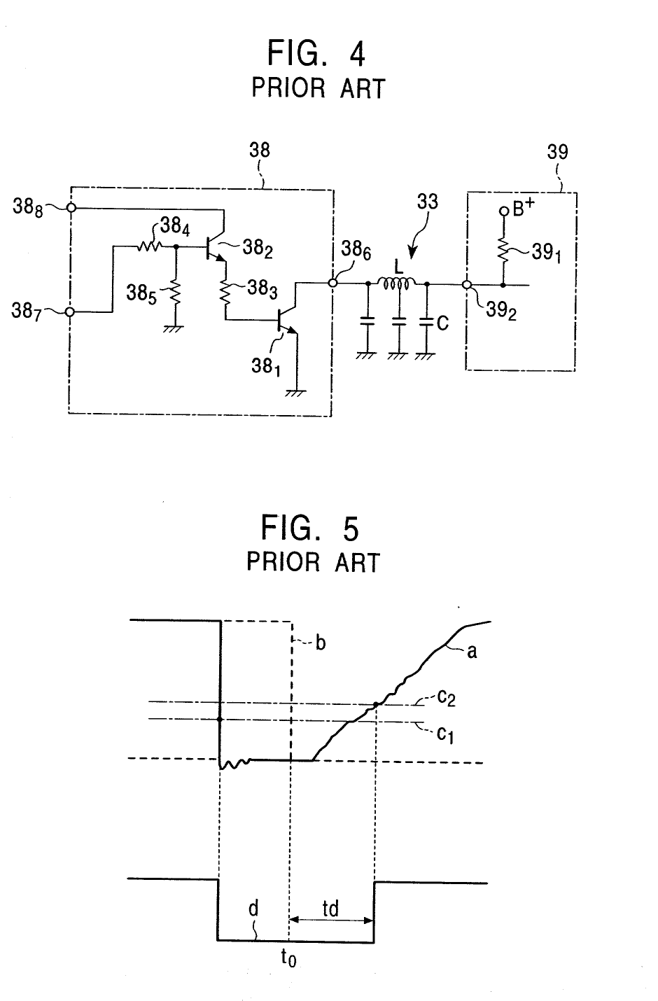

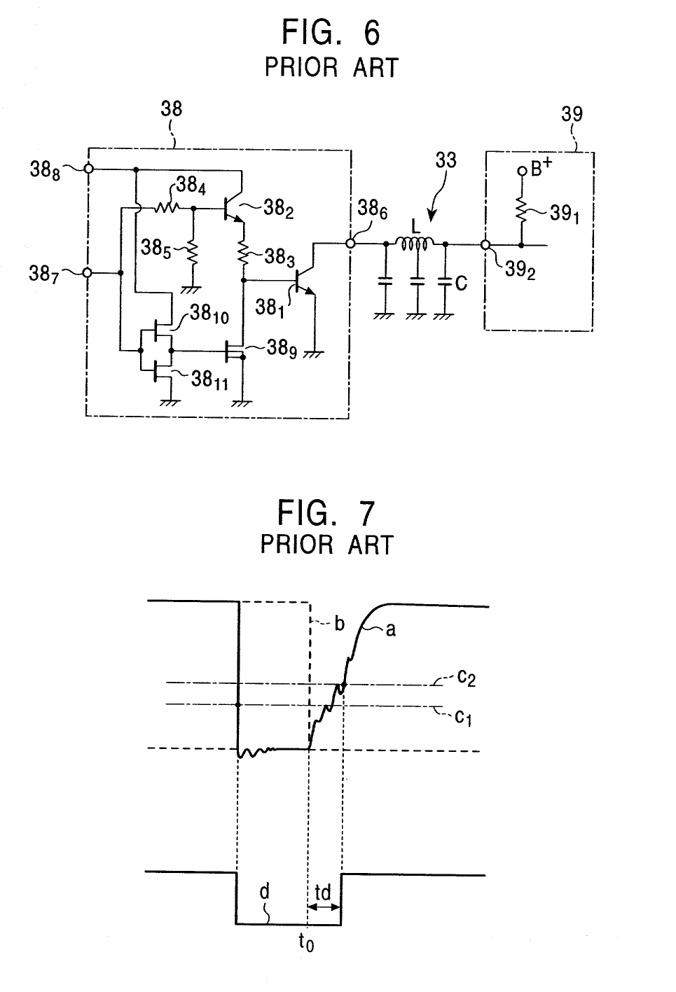

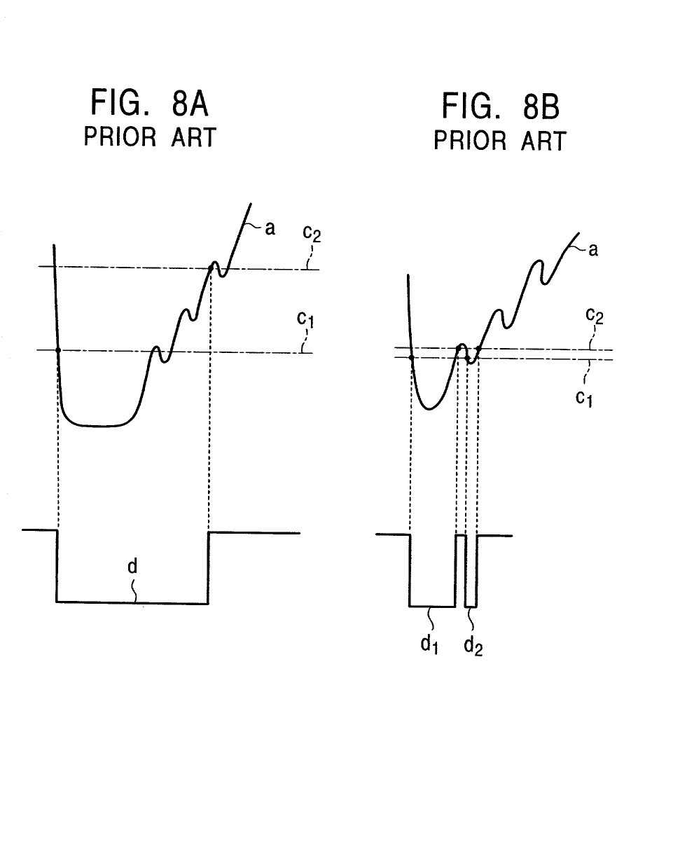

FIG. 1 is a schematic circuit diagram of one example of a data output unit and a read data input unit, which are components of an information recording and reproducing apparatus as with those shown in FIG. 3, showing one embodiment of a floppy disk drive according to the present invention.

As shown in FIG. 1, a circuit arrangement of this embodiment comprises a data output unit 1 as one component of a floppy disk drive (FDD), a read data (RD) input unit 2 of a main controller constituted by a personal computer (PC), and set cables 3 for coupling the data output unit 1 and the read data input unit 2 to each other.

In this embodiment, the data output unit 1, which is preferably constituted in its entirety by an integrated circuit (IC), comprises an output transistor 4, a pull-up driving transistor 5 connected in emitter follower arrangement, a pull-down driving field effect transistor 6 having a grounded source, an emitter serial resistance 7, a current limiting resistance 8, two voltage-dividing base resistances 9, 10, complementary field effect transistors 11, 12 having grounded sources, an intra-drive data output terminal 13, an intra-drive data input terminal 14, and a power source terminal 15. The read data input unit 2 comprises a pull-up resistance 16 and a data input terminal 17. The set cable 3 has a serial inductance L and a distributed capacitance C as equivalent values. A resistance value of the current limiting resistance 8 is preferably set to be several, e.g., four, times that of the emitter serial resistance 7.

The output transistor 4 has a collector connected to the intra-drive data output terminal 13, and has an emitter grounded. The pull-up driving transistor 5 has an emitter connected to a base of the output transistor 4 through the emitter serial resistance 7, and has a collector connected to the power source terminal 15. The pull-down driving field effect transistor 6 has a drain connected to the base of the output transistor 4 through the current limiting resistance 8, and has a grounded source. The voltage-dividing base resistance 9 is connected at one end to the intra-drive data input terminal 14, and at the other end to a base of the pull-up driving transistor 5. The voltage-dividing base resistance 10 is connected at one end to the base of the pull-up driving transistor 5, and is grounded at the other end. The field effect transistor 11 has a source connected to a gate of the pull-down driving field effect transistor 6, has a drain connected to the power source terminal 15, and has a gate connected to the intra-drive data input terminal 14. The field effect transistor 12 has a drain connected to the gate of the pull-down driving field effect transistor 6, has a source grounded, and has a gate connected to the intra-drive data input terminal 14.

Further, the pull-up resistance 16 is connected at one end to a power source terminal (B⁺), and at the other end to the data input terminal 17. The set cable 3 is connected at one end to the intra-drive data output terminal 13, and at the other end to the data input terminal 17.

FIG. 2 is a waveform chart showing read data obtained at the data input terminal 17 and a data detection signal outputted from the read data input unit 2 in the embodiment shown in FIG. 1.

Referring to FIG. 2, a solid line a represents the read data obtained at the data input terminal 17, a dotted line b represents intra-drive read data supplied to the intra-drive data input terminal 14, one-dot-chain lines c₁, c₂ represent two thresholds, and d represents the data detection signal.

The operation of the circuit of this embodiment shown in FIG. 1 will be described below with reference to the waveform chart of FIG. 2 as well.

In a floppy disk drive (not shown in FIG. 1), when data recorded on a floppy disk (also not shown) is read, the intra-drive read data is supplied to the intra-drive data input terminal 14 at predetermined timing. The waveform of the intra-drive read data at that time is substantially rectangular as indicated by the dotted line b in FIG. 2. Then, the intra-drive read data supplied to the intra-drive data input terminal 14 is divided into two parts, one of which is supplied to the pull-up driving transistor 5 after being adjusted in level by the voltage-dividing base resistances 9, 10. When the intra-drive read data supplied to the intra-drive data input terminal 14 is at a positive level, the pull-up driving transistor 5 is driven and supplies a pull-up current to the base of the output transistor 4 through the emitter serial resistance 7. Upon the supply of the pull-up current, the output transistor 4 is turned on and a collector current flows into the output transistor 4 through the pull-up resistor 16 and the set cable 3, whereby the intra-drive read data is amplified with the phase inverted. The other part of the intra-drive read data is amplified by the complementary field effect transistors 11, 12 with the phase inverted and then supplied to the pull-down driving field effect transistor 6. When the intra-drive read data supplied to the intra-drive data input terminal 14 takes a low level (L-level), the pull-down driving field effect transistor 6 is driven and gains a pull-down current from the base of the output transistor 4. At that time, the pull-down current is obtained at a proper value by selecting the resistance value of the current limiting resistance 8 to be several times that of the emitter serial resistance 7. Because the proper value of the pull-down current is obtained, the pull-down driving field effect transistor 6 functions, in a more effective manner, to quickly attenuate a residual current due to the charge accumulation effect of the pull-up driving transistor 5, and to more promptly cut off the output transistor 4.

The read data obtained from the output transistor 4 through the above-described cooperative operations and having the inverted phase is supplied from the intra-drive data output terminal 13 to the data input terminal 17 via the set cable 3 so that the read data is inputted to the read data input unit 2. The waveform of the read data inputted to the read data input unit 2 is as represented by the solid line a in FIG. 2; that is, it has the phase inverted with respect to the waveform of the intra-drive read data represented by the dotted line b and has a rising edge with a relatively steep slope because the read data is subjected to the effect of the inductance L of the set cable 3, but just slightly affected by the charge accumulation effect of the pull-up driving transistor 5. In addition, undulations occurred in the waveform of the rising edge are suppressed.

The slope of the rising edge of the read data obtained in this embodiment is steeper than that obtained in the conventional first circuit described above, and is slightly gentler than that obtained in the conventional second circuit described above. Also, comparing with an arrival time t₀ of a falling edge of the intra-drive read data supplied to the intra-drive data input terminal 14, the timing of the rising edge of the read data is closer to the arrival time t₀ than that in the conventional first circuit, and slightly farther away from the arrival time t₀ than that in the conventional second circuit. Further, a delay time td of the stop time (rising edge) of outputting of the data detection signal from the arrival time t₀ of the falling edge of the intra-drive read data is much shorter than that in the conventional first circuit, and is almost equal to that in the conventional second circuit.

Also in the circuit of this embodiment, the read data input unit 2 has the two thresholds c₁, c₂ as represented by the one-dot-chain lines in FIG. 2. At the time the falling edge of the supplied read data intersects the lower threshold cl, the data detection signal d at a low level (L-level) is outputted, and then at the time the rising edge of the supplied read data intersects the upper threshold c₂, the data detection signal d shifts to a high level (H-level), whereupon the outputting of the data detection signal d is stopped.

In the circuit of this embodiment, since undulations occurred in the waveform of the rising edge a of the read data are suppressed by setting the pull-down current so as to flow at a proper value through the pull-down driving field effect transistor 6, the following advantage is obtained. In the operation of the read data input unit 2 having the two thresholds c₁, c₂ wherein the data detection signal d is outputted at the time the falling edge of the read data intersects the lower threshold c₁, and the outputting of the data detection signal d is stopped at the time the rising edge of the read data intersects once the upper threshold c₂, it is surely avoided that a falling side of one concave portion of the undulations in the rising edge of the read data again intersects the lower threshold c₁, and then a rising side of the concave portion again intersects the upper threshold c₂. Therefore, the read data input unit 2 is able to reliably generate one data detection signal d each time the falling edge of the read data arrives once, and is surely kept from generating a false data detection signal.

Further, with the circuit of this embodiment, the above advantage is ensured even in the case in which the two thresholds c₁, c₂ of the integrated circuit (IC) constituting the read data input unit 2 are relatively close to each other. Stated otherwise, undulations in the waveform of the rising edge a of the read data are suppressed to such an extent as preventing a phenomenon that after one data detection signal d has been generated, a falling side of one concave portion of the undulations in the rising edge of the read data again intersects the lower threshold c₁, and then a rising side of the concave portion again intersects the upper threshold c₂. The probability of generating the data detection signal d again is thereby reduced to a very small value. Even in the case of having the two thresholds close to each other, therefore, the read data input unit 2 is able to reliably generate one data detection signal d each time the falling edge of the read data arrives once, and is surely kept from generating a false data detection signal.

While the circuit of this embodiment has been described in connection with the example in which the read data input unit 2 generates the data detection signal based on the read data supplied from the data output unit 1, the type of data, to which the present invention is applicable, is not limited to the read data. As a matter of course, the present invention can also be applied to an index (IDx) signal that is generated through an operation process similar to that for generating the data detection signal.

What is claimed is:

1. A floppy disk drive comprising at least a data read/write unit for reading or writing data through a head, motor drivers for driving a spindle motor and a stepping motor, a control unit for controlling overall operation of said floppy disk drive, and a data output unit for supplying data to a main controller via a set cable, said data output unit comprising an output transistor outputting the data to said set cable and supplied with a pull-up current from said main controller via said set cable, and a pull-up transistor and a pull-down transistor connected in series between a power source terminal and a ground, wherein said pull-up transistor and said pull-down transistor include driving transistors for driving said output transistor in cooperation, and a current limiting resistance is connected in series to said pull-down transistor.

2. A floppy disk drive according to claim 1, wherein said pull-up transistor is a transistor having an emitter serial resistance and connected in emitter follower arrangement, and said pull-down transistor is a field effect transistor having a grounded source with said current limiting resistance connected to a drain of said field effect transistor.

3. A floppy disk drive according to claim 2, wherein said current limiting resistance has a resistance value several times a resistance value of said emitter serial resistance.
